(19) United States
(12) Patent Application Publication
(10) Pub. No.: US 2021/0170466 A1
(43) Pub. Date: Jun. 10, 2021

(54) DETERMINING THE BEND DEDUCTION OF A SHEET METAL WORKPIECE TO BE BENT

(71) Applicant: TRUMPF Maschinen Austria GmbH & Co. KG., Pasching (AT)

(72) Inventor: Harald KNEIDINGER, Hoersching (AT)

(73) Assignee: TRUMPF Maschinen Austria GmbH & Co. KG., Pasching (AT)

(21) Appl. No.: 16/763,333

(22) PCT Filed: Dec. 19, 2018
(86) PCT No.: PCT/AT2018/060310

§ 371 Date: May 12, 2020

(30) Foreign Application Priority Data
Dec. 22, 2017 (AT) A 51081/2017

(51) Int. Cl. B21D 5/00

(52) U.S. Cl. CPC B21D 5/006

(57) ABSTRACT

The invention relates to method for estimating a shortening length of a sheet metal workpiece which is bent about n bending axes and by n bending angles alpha, comprising the following method steps, wherein

the bent sheet metal workpiece comprises n+1 limbs extending along a straight extension line and n curved regions which are produced by bending the sheet metal workpiece and extend between two adjacent limbs.

The invention relates to a method for estimating a shortening length of a sheet metal workpiece which is bent about n bending axes and by n bending angles alpha, wherein the bent sheet metal workpiece comprises n+1 limbs extending along a straight extension line and n curved regions which are produced by bending the sheet metal workpiece and extend between two adjacent limbs.

The letter n stands for a natural number; i.e. n=1, 2, 3, 4 . . . .

A difficulty in bending a sheet metal strip about a bending axis consists in selecting the original length of the sheet metal strip such that the bent sheet metal strip has defined dimensions. During the bending operation, according to the standard teaching, depending on the workpiece to be bent, compression occurs on the inside of the curvature area, while the material on the outside of the curvature area is subject to stretching. The extent of compression and stretching of the workpieces on the inside and on the outside of the curvature is hard to predict due to the plurality of the influencing factors.

DE112012000792 suggest a method for determining the original dimensions of a sheet metal workpiece prior to bending into a sheet metal construction, said method being based on the determination of a length H3 and the determination of angles. When looking at the bent workpiece as a triangle, the length H3 essentially corresponds to the height of the triangle.

The method according to the invention differs from the method disclosed in DE112012000792 in that it can be carried out without the determination of the length H3 and without the determination of the angles and can thus be carried out in a simple manner.

EP1398094 relates to a method for determining the arm length of a bending part in a bending device. However, in EP1398094 there is no indication of the determination of the shortening lengths as are part of the method according to the invention. EP1398094 is in particular limited to the determination of one arm length only.

EP2683504 describes a method for dynamic correction of a bending angle of a sheet metal material on a panel bender machine. The method described therein is inter alia based on the determination of the nominal bending angle and the distance of the bending punch from the bent sheet metal, after the bending punch has been brought back into a retracted position. The method that will be described below goes without the determination of these parameters.

DE10009074 relates to a method for air bending or swivel bending of a workpieces as well as a device for determining the position of a workpiece leg during bending. In DE10009074, there is no indication of a determination of the lengths and distances and the calculation of the shortening as described in the method according to the invention.

DE10163956 describes a method and a device for measuring lengths on a workpiece deformed by bending. In DE10163956, there is no indication of the calculation of the shortenings as described in the method according to the invention.

The methods according to the prior art are generally not easy to perform. It is the object of the present invention to overcome the shortcomings of the prior art for determining the shortening of a sheet metal workpiece taking place as a result of a bending process about a bending axis.

The invention discussed below in particular faces the object of being able to determine the shortening occurring when a sheet metal workpiece is bent in a method that is as simple as possible and with an exactness that is as high as possible in the sense of an estimation. With the aid of the method according to the invention, it should in particular be simple to determine changes in the bending behavior of a plurality of sheet metal workpieces to be bent, in particular the behavior of a plurality of the sheet metal workpiece to be bent in view of the shortening taking place.

This object is achieved by means of a method according to the claims.

The method according to the invention is mainly, but not in a limited manner, directed towards sheet metal workpieces having a thickness that remains constant over the surface of extent of the sheet metal workpiece. This does not preclude that the thickness can vary for example within the range of the boundaries defined by relevant standards.

The method according to the invention is mainly directed towards bent sheet metal workpieces which are produced by means of a die bending tool by cold bending. The bent sheet metal workpieces can be produced considering DIN6935.

The estimation of the shortening resulting from bending a sheet metal workpiece about a bending axis can take place by the determination of a tangent shortening, the method for tangent shortening comprising the following steps:
determining the original length L0 of the sheet metal strip prior to bending of the sheet metal workpiece,
determining the intersection of the straight extension lines of adjacent limbs or of straight lines parallel to the straight extension lines, said straight lines running at the surfaces of the limbs facing away from the respective bending axis,
determining the i distances A1, A2 between the intersections and the free ends of the limbs and optionally if n>2 determining the j distances B1 between the intersections,
determining a tangent shortening T according to the formula:

$$T = L 0 - {\sum }_{i = 1}^{n + 1} {A}_{i} - {\sum }_{j = 1}^{n - 1} {B}_{j}$$

A sheet metal workpiece with n=1 bending axes comprises two limbs and a curved region extending between the limbs. Thus, merely the distances A1 and A2 can be determined.

A sheet metal workpiece with n=2 bending axes comprises three limbs and two curved regions extending between two adjacent limbs. Thus, two distances A1, A2 and one distance B1 can be determined.

The number of distances A that can be determined and the number of distances B that can be determined are predefined by the geometric givens.

The estimation of the shortening resulting from bending a sheet metal workpiece about a bending axis can take place by the determination of an edge shortening, the method for tangent shortening comprising the following steps:
determining the original length L0 of the sheet metal strip prior to bending of the sheet metal workpiece,
determining k edge lengths C of the bent sheet metal workpiece, said edge lengths C each indicating a distance from a free end of a limb to a tangent point to be measured in parallel to the straight extension line of the limb, at which tangent point a tangent normal to the first straight extension line is tangent to the curved region,
optionally 1 edge lengths D of the bent sheet metal workpiece, said edge lengths D indicating a distance from a tangent point to a further tangent point to be measured in parallel to the straight extension line of the limb, at which tangent points tangents normal to the straight extension lines are tangent to the curved region,
calculating the edge shortening length K according to the following formula:

$$K = L 0 - {\sum }_{k = 1}^{n + 1} {C}_{k} - {\sum }_{l = 1}^{n - 1} {C}_{l}$$

A sheet metal workpiece with n=1 bending axes comprises two limbs and a curved region extending between the limbs. Thus, merely the distances C1 and C2 can be determined.

A sheet metal workpiece with n=2 bending axes comprises three limbs and two curved regions extending between two adjacent limbs. Thus, two distances C1, C2 and one distance D1 can be determined.

The number of distances C that can be determined and the number of distances D that can be determined are predefined by the geometric givens.

The presently disclosed invention also relates to a device for determining an edge shortening length of a sheet metal workpiece, said device comprising a first measuring element surface and a second measuring element surface, wherein the first measuring element surface and the second measuring element surface are placed at a right angle to each other.

The measuring element surfaces are designed such that the surface of the limbs of the sheet metal tool can be placed against the measuring element surfaces and the edge lengths of the sheet metal tool can be determined by determination of a distance of the free end of the sheet metal tool from the intersection of the measuring element surfaces.

Such a device according to the invention can comprise contacting measuring device and/or contactless measuring devices for the determination of the distances of the free end from the intersection of the measuring element surfaces.

The second measuring element surface, by means of which second measuring element surface the limb is brought into contact with the edge length to be determined, can have a length L2 that is smaller than the edge length C to be determined. This formation allows for determination of the edge length C by overhang measure.

For the purpose of better understanding of the invention, it will be elucidated in more detail by means of the figures below.

These show in a respectively very simplified schematic representation:

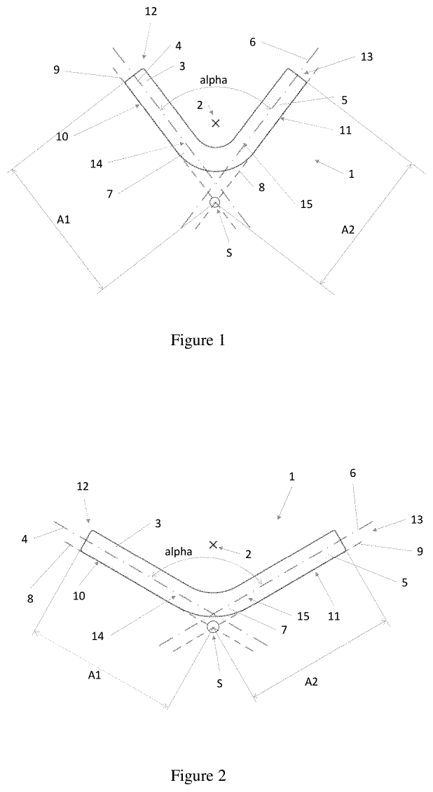

FIG. 1 the geometric proportions of a sheet metal workpiece bent about a bending axis having a bending angle alpha<90° for determining edge shortening;

FIG. 2 the geometric proportions of a sheet metal workpiece bent about a bending axis having a bending angle 90<alpha<1800 for determining edge shortening;

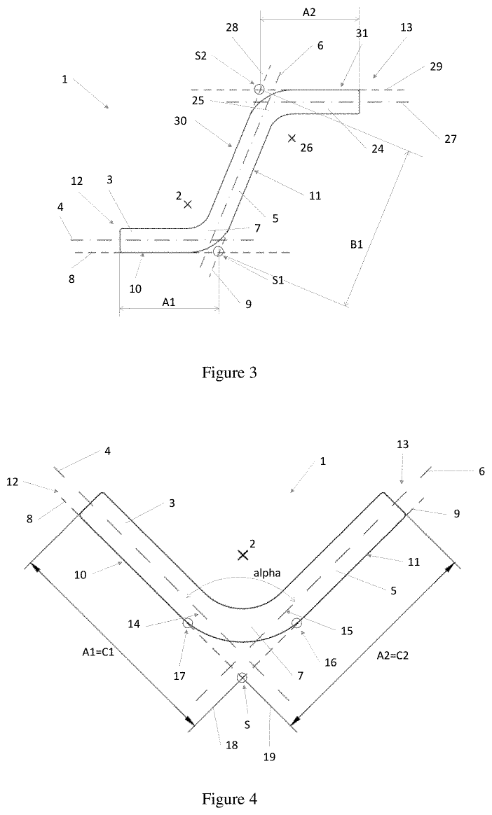

FIG. 3 the geometric proportions of a sheet metal workpiece bent about two bending axes having a bending angle 90<alpha<180° for determining edge shortening;

FIG. 4 the geometric proportions of a sheet metal workpiece bent about a bending axis having a bending angle alpha<90° for determining tangent shortening;

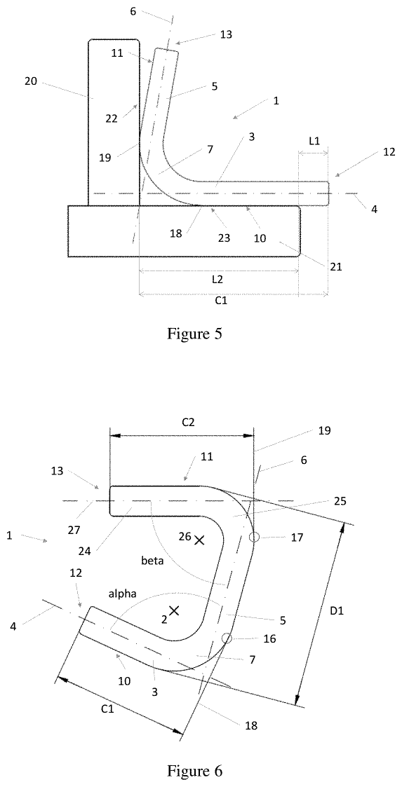

FIG. 5 a measuring device for determining the tangent shortening;

FIG. 6 the geometric proportions of a sheet metal workpiece bent about two bending axes having two bending angles alpha<90° for determining tangent shortening;

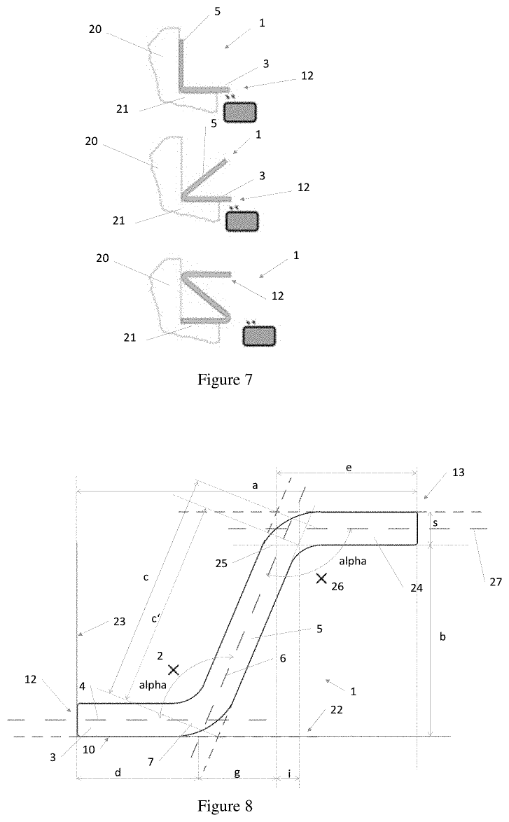

FIG. 7 possibilities for determining the tangent shortening;

FIG. 8 the determination of the tangent shortening of a multiply bent sheet metal workpiece.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position. For the sake of clarity, not all elements are provided with reference numbers in all figures.

FIG. 1 and FIG. 2 illustrate the lengths and distances to be determined on a sheet metal workpiece 1, said sheet metal workpiece 1 having been bent about a bending axis 2 by a bending angle alpha. The determination of the tangent shortening T mentioned in the description of FIG. 1 and FIG. 2 as a method according to the invention for estimating a shortening occurring during bending of a sheet metal workpiece about a bending axis 2 oriented so as to be normal to the image plane of FIG. 1 and FIG. 2 is possible for all bending angles alpha<180°. FIG. 1 shows a sheet metal workpiece 1 bent about a bending axis 2 with a bending angle alpha<90° and FIG. 1 shows a sheet metal workpiece 1 bent about a bending axis 2 with a bending angle 90°<alpha<180°.

The sheet metal workpieces 1 shown in FIG. 1 and FIG. 2 each have a bending axis 2, such that n=1.

The bent bending workpieces 1 shown in FIG. 1 and in FIG. 2 each comprise a first limb 3, said first limb 3 extending along a first straight extension line 4, a second limb 5, said second limb 5 extending along a second straight extension line 6, and a curved region 7 extending between the first limb 3 and the second limb 5. The respective transition between the limbs 3, 4 and the curved region 7 is geometrically defined by the extension of the limbs 3, 4 and the polygonal extension of the curved region 7, wherein the first transition point 14 between the first limb 3 and the curved region 7 as well as the second transition point 15 between the second limb 5 and the curved region 7 are hard to determine on the sheet metal workpiece 1.

The curved region 6 has a polygonal shape, wherein the first limb 3 and/or the second straight extension line 4 and the second limb 5 and/or the second straight extension line 5 are each tangential to the end points of the curved region 7.

The person skilled in the art is capable of determining the original length L0 of the sheet metal workpiece prior to bending, which is not shown in any figure, of the sheet metal workpiece 1 about the bending axis 2 using measuring methods according to the prior art. The original length L0 is defined as the length that can be measured between the free ends 12, 13 of the sheet metal workpiece 1.

The person skilled in the art determines the intersection S additionally marked by a circle between a first straight line 8 and a second straight line 9, the first straight line 8 and the second straight line 9 being parallel straight lines to the first straight extension line 4 and/or to the second straight extension line 6. The first straight line 8 is the straight line parallel to the first straight extension line 4, said first straight line 8 being a tangent to the outer first surface 10 of the first limb 3. The second straight line 9 is the straight line parallel to the second straight extension line 6, said second straight line 9 being a tangent to the outer second surface 11 of the second limb 5.

The intersection S can be determined such that a first measuring element is placed against the outer first surface 10 and a second measuring element is placed against the outer second surface 11. The measuring elements placed against the outer surfaces with their edges placed against the surfaces extend congruently with the first straight line 8 and/or with the second straight line.

After the determination of the intersection S, the person skilled in the art is capable of determining the lengths A1 and A2 entered in FIG. 1. According to the definition, length A1 is the length measured between the free first end 12 of the first limb 3 and the intersection S. According to the definition, length A2 is the length measured between the free second end 13 of the second limb 5.

The person skilled in the art determines the tangent shortening T from the measured original length L0 of the sheet metal workpiece with the aid of the length A1 and the length A2 according to the formula T=L0−A1−A2.

The method according to the invention for estimating the shortening of a sheet metal workpiece can also be applied to a bent sheet metal workpiece comprising n limbs. FIG. 3 illustrates an application of the method according to the invention to a sheet metal workpiece 1 comprising a first limb 3, a second limb 5, a third limb 24. A first curved region 7 extends between the first limb 3 and the second limb 5 and a second curved region 25 extends between the second limb 5 and the third limb 24. The first curved region 7 is produced by bending of the sheet metal workpiece 1 about a first bending axis 2 and the second curved region 25 is produced by bending of the sheet metal workpiece 1 about a second bending axis 26. FIG. 3 relates to the special case that the sheet metal workpiece 1 during bending about the first bending axis 2 and during bending about the second bending axis 26 is respectively bent by a bending angle alpha.

The first limb 3 extends along a first straight extension line 4, the second limb 5 and the third limb 24 extend along a second straight extension line 6 and/or along a third straight extension line 27.

The person skilled in the art determines the first intersection S1 as an intersection of the first straight line 8 with the second straight line 9. The intersections S1 and S2 are additionally marked by a circle in FIG. 3. The first straight line 8 extends in the first surface 10 of the first limb 3, said first surface 10 facing away from the first bending axis 2 and being parallel to the first straight extension line 4. The second straight line 9 runs in the second surface 11 of the second limb 5, said second surface 11 facing away from the first bending axis 2 and being parallel to the second straight extension line.

Then, the intersection S2 as an intersection of the third straight line 28 with the fourth straight line 29 is determined. The third straight line 28 extends in the third surface 30 of the second limb 5 facing away from the second bending axis 26 and is parallel to the second extension axis 6. The fourth straight line 29 runs in the fourth surface 31 of the third limb 24, said fourth surface 31 being the surface of the third limb 24 that faces away from the second bending axis 26 and being parallel to the third straight extension line 27.

The person skilled in the art lastly determines the distance A1 as the distance between the first free end 12 of the sheet metal workpiece 1 and the first intersection S1, the distance A2 as the distance between the second end 13 of the sheet metal workpiece 1 and the second intersection S2 and the distance B1 between the intersections S1 and S2. The mentioned distances are measured in parallel to the first straight extension line 3 and/or to the second straight extension line 6 and/or to the third straight extension line 27. The distance A1 is parallel to the first extension line 4, the distance A2 is parallel to the third extension line 27 and the distance B1 is parallel to the second extension line 6.

The person skilled in the art calculates the tangent shortening defined by the disclosure of the invention by T=L0−A1−A2−B1.

FIG. 4 illustrates the lengths and distances to be determined on a sheet metal workpiece 1, the sheet metal workpiece 1 having been bent about a bending axis 2 by a bending angle alpha in order to determine the edge shortening K; the edge shortening can be determined after bending of a sheet metal workpiece about a bending axis 2 and by a bending angle smaller than or equal to 90°.

The person skilled in the art is capable of measuring the original length L0 of the undeformed sheet metal workpiece 1 which is shown in no figure. The original length L0 is the length that can be measured between the free ends 12, 13 of the undeformed sheet metal piece 1.

The sheet metal workpiece 1 bent about a bending axis 2 oriented normal to the image plane of FIG. 4 comprises a first limb 3, said first limb extending along a first straight extension line 4, a second limb 5 extending along a second straight extension line 6 and a polygonal curved region 7 extending between the limbs 3, 4. The straight extension lines 4, 5 form the tangents to the curved region 7.

The straight extension lines 4, 5 contact the curved region 7 at a first transition point 14 and/or at a second transition point 15, which transition points 14, 15 are geometrically clearly defined, but are difficult to determine on the bent sheet metal workpiece 1.

The person skilled in the art determines the first tangent point 16, at which first tangent point 16, a straight line oriented normal with respect to the first straight extension line 4 forms a first tangent 18 to the curved region 7. Moreover, the second tangent point 17 can be determined, at which second tangent point 17, a straight line oriented normal with respect to the second straight extension line 6 forms a second tangent 19 to the curved region 7. The tangent points 16, 17 are additionally marked by circles.

A first edge length C1 can be measured on the bent sheet metal workpiece, said first edge length C1 being defined as the distance between the first free end 12 and the first tangent point 16, the distance being parallel to the first straight extension line 4. In like manner, a second edge length C2 on the bent sheet metal workpiece 1 can be determined, which second edge length C2 can be measured as the distance to be measured in parallel to the second straight extension line 6 between the second free end 13 and the second tangent point 17.

The first edge length C1, for example, can be measured in a very simple manner using a caliper. For this purpose, the inner edges of the outer measuring jaws for external dimensions of objects are placed against the first free end 12 and against the outer surface of the curvature 7 and the edge of the bar of the caliper facing the outer jaws is placed against the first surface 10. By placing the edge of the bar of the caliper against the first surface, the first tangent point 16 is determined and the first edge length C1 is measured.

In like manner, the second edge length C2 is determined by placing the inner edges of the outer measuring jaws against the second free end 13 and against the outer surface of the curvature 7 and placing the edge of the bar of the caliper facing the outer measuring jaws against the first surface 11.

Finally, the person skilled in the art is capable of estimating the shortening of the sheet metal workpiece 1 occurring due to bending of the sheet metal workpiece 1 about the bending axis 2 and by an angle alpha<90° by calculating the edge shortening. The edge shortening can be calculated by means of the formula K=L−C1−C2.

FIG. 4 illustrates the special case of a bending angle alpha=90°. In analogy to the figure descriptions above for FIG. 1 to FIG. 3, the person skilled in the art is able to determine the intersection S as an intersection of the first straight line 8 and the second straight line 9. In this regard, the construction operations described in sufficient detail above are to be applied. The intersection S is additionally marked by a circle in FIG. 4. The distance A1 and the distance A2 also are to be determined analogously to the description above, with the person skilled in the art recognizing that in the special case of a bending angle alpha=90° shown in FIG. 4, A1=C1 and A2=C2 apply. It further applies to the special case of alpha=90° L0−C1−C2=K=T=L0−A1−A2.

FIG. 5 illustrates a further method for determining the edge lengths C1, C2 on a bent sheet metal workpiece 1 having a bending angle alpha smaller than or equal to 90°.

The measuring arrangement comprises a first measuring element 20 and a second measuring element 21 having a first measuring element surface 22 and/or a second measuring element surface 23. The measuring element surfaces 22, 23 are arranged at an angle of 90° with respect to one another. The second measuring element surface 23 has a known length L2.

The measuring elements 20, 21 can be parts of a bending machine.

The bent sheet metal workpiece 1 is placed against the measuring surface 22, 23 with its outer surface. For determining the first edge length C1, the first surface 10 contacts the second measuring element surface 23 and the outer surface of the curved region 7 contacts the first measuring element surface 22.

FIG. 5 shows a sheet metal workpiece 1 having a bending angle alpha equal to 80°. The first measuring element surface 22 contacts the outer surface of the curved region 7 the first measuring element surface 22.

Since the length L2 is known, the person skilled in the art is capable of determining the first edge length C1 by determining the overhang measure L1. The measure L1 can for example be determined by means of contactless measuring methods.

For determining the second edge length C2, the person skilled in the art places the bent sheet metal workpiece 1 with the second surface 11 against the second measuring element surface 23 and with the outer surface of the curved region 7 against the first measuring element surface 22, to hence, in turn, determine the second edge length B via measuring the overhang measure L1. The process of determining the second edge length C2 is not shown in FIG. 5.

FIG. 6 illustrates the method for estimating the shortening of a sheet metal workpiece 1 bent about two bending axes 2, 26 comprising a first bending angle alpha smaller than or equal to 900 and a second bending angle smaller than or equal to 90°.

The sheet metal workpiece 1 comprises a first limb 3, a second limb 5 and a third limb 24, said limbs 3, 5, 24 extending along straight extension lines 4, 6, 27. The first limb 3 and the second limb 5 are separated by the first curved region 7. The second limb 5 and the third limb 25 are separated by the second curved region 25.

For measuring the first edge length C1, the person skilled in the art places the edges of the bar of a caliper (not shown in FIG. 6) against the first surface 10 of the first limb 3, said first surface 10 being the surface of the first limb 3 facing away from the first bending axis 2. The person skilled in the art further places the inner edge of an outer measuring jaw against the first free end 12 and an inner of the other outer measuring jaw against the first curved region 7. By placing the bar against the first surface 10, the inner edge of the other outer measuring jaw contacts the first curved region 7 at the first tangent point 16.

The determination of the second edge length C2 is carried out in like manner, wherein the edge of the bar of the caliper (not shown in FIG. 6) is placed against the second surface 11 of the third limb 24. The inner edges of the outer measuring jaw in turn contact the second free end 13 of the sheet metal workpiece 1 and the second tangent point 17.

For determining the edge length D1, the edge of the bar of the caliper (not shown in FIG. 6) is placed against the third surface 30 of the second limb 5 and the inner edges of the outer measuring jaw are placed against the first curved region 7 and against the second curved region 25.

The person skilled in the art calculates the edge shortening of the sheet metal workpiece 1 as a result of bending of the sheet metal workpiece 1 about the first bending axis 2 and about the second bending axis 26 by means of the formula K=L-C1-C2-D1.

In the description to FIG. 6, the construction of the tangents et cetera is not described in such detail as in the figure descriptions above, to illustrate, also by means of the written description, how easily the method according to the invention can be carried out.

FIG. 7 in addition to FIG. 5 illustrates how the sheet metal workpieces 1 shortened as a result of bending and shown in exemplary shapes can be measured using the method according to the invention such that the shortening can be estimated. As was initially elucidated in the description of FIG. 5 above, the bent sheet metal workpiece 1 is placed in the measuring device formed by the first measuring element 20 and the second measuring element 21 such that the sheet metal workpiece 1 contacts the measuring device and a free end 12 can be measured.

The tangent shortening is determined for each of the sheet metal workpieces 1 shown in FIG. 7.

By means of FIG. 8, it is explained how, by measuring the free end, the shortening of a sheet metal workpiece 1 bent about a first bending axis 2 and about a second bending axis 26 is estimated by application of the method according to the invention. The sheet metal workpiece 1 comprises a first limb 3 extending along a first straight extension line 4, a second limb 5 extending along a second straight extension line 6 and a third limb 24 extending along a third straight extension line 27. The sheet metal workpiece 1 comprises a first curved region 7 extending between the first limb 3 and the second limb 5 and a second curved region 25 extending between the second limb 5 and the third limb 24. The first curved region 7 and the second curved region 25 are produced by bending of the sheet metal workpiece 1 about a first bending axis 2 and/or about a second bending axis 26 by a bending angle alpha. The bent sheet metal workpiece 1 shown in FIG. 8 thus has two equal bending angles.

The bent sheet metal workpiece 1 is placed in a measuring device comprising a first measuring element surface 22 and a second measuring element surface 23 with its first end 12 for measurement. For the sake of clarity merely the measuring element surfaces 22, 23, which are arranged at a right angle with respect to one another, are shown in FIG. 8.

The sheet metal workpiece 1 with its first end 12 contacts the second measuring element surface 23 and with its first surface 10 contacts the first measuring element surface 22, whereby the sheet metal workpiece 1 is also oriented towards the measuring device.

The second end 13 of the sheet metal workpiece 1 is measure applying contactless and/or contacting measuring methods according to the prior art, wherein in particular the distance a and the distance b to the first measuring element surface 22 and/or to the second measuring element surface 23 is/are determined.

The person skilled in the art hence known the distance a and the distance b as well as the bending angle alpha as well as the sheet metal thickness s.

It therefore applies due to the geometric relations, which the person skilled in the art can read from FIG. 8:

$${c}^{′} = \frac{b}{sin ( ∝ )}$$

$$c = {c}^{′} + h$$

$$h = s \cdot tan ( \frac{α}{2} )$$

$$c = \frac{b}{s i n ( α )} + s \cdot tan ( \frac{α}{2} )$$

$${g}^{′} = \frac{b}{t a n ( α )} - s \cdot tan ( \frac{α}{2} )$$

$$a - g = d + e \\ T = L 0 - ( c + d + e ) \\ T = L 0 - ( c + a - g ) \\ T = L 0 - ( \frac{b}{s i n ( α )} + s \cdot tan ( \frac{α}{2} ) + a - \frac{b}{t a n ( α )} - s \cdot tan ( \frac{α}{2} ) )$$

$$T = L 0 - ( \frac{b}{s i n ( α )} \cdot ( 1 - cos ( α ) ) + 2 \cdot s \cdot tan ( \frac{α}{2} ) + a )$$

The exemplary embodiments show possible embodiment variants of the method according to the invention, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field. The person skilled in the art does not have to exercise an inventive step for this.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

All methods for determining distances can also be supplemented or replaced by other methods in accordance with the prior art and/or by the application of known teaching.

Finally, as a matter of form, it should be noted that for ease of understanding of the structure, elements are partially not depicted to scale and/or are enlarged and/or are reduced in size.

List of reference numbers

| | |
|---|---|
| 1 | sheet metal workpiece |
| 2 | (first) bending axis |
| 3 | first limb |
| 4 | first straight extension line |
| 5 | second limb |
| 6 | second straight extension line |
| 7 | first curved region |
| 8 | first straight line |
| 9 | second straight line |
| 10 | first surface |
| 11 | second surface |
| 12 | first end |
| 13 | second end |
| 14 | first transition point |
| 15 | second transition point |
| 16 | first tangent point |
| 17 | second tangent point |
| 18 | first tangent |
| 19 | second tangent |
| 20 | first measuring element |
| 21 | second measuring element |
| 22 | first measuring element surface |
| 23 | second measuring element surface |
| 24 | third limb |
| 25 | second curved region |
| 26 | second bending axis |
| 27 | third extension axis |
| 28 | third straight line |
| 29 | fourth straight line |
| 30 | third surface |
| 31 | fourth surface |
| S | intersection |
| Aᵢ | distance |
| Bⱼ | distance |
| Cₖ | distance |
| Dₗ | distance |

1: A method for estimating a shortening length of a sheet metal workpiece which is bent about n bending axes and by n bending angles alpha,
wherein a measuring arrangement with a first measuring element surface (22) of a first measuring element (20) and with a second measuring element surface (23) of a second measuring element (21) is used, and
wherein the measuring elements (20, 21) are formed by parts of the bending machine and the first and the second measuring element surfaces (22, 23) are arranged at an angle of 90° relative to one another, and
wherein the bent sheet metal workpiece comprises n+1 limbs extending along a straight extension line and n curved regions which are produced by bending the sheet metal workpiece and extend between two adjacent limbs, comprising the following method steps:
determining the original length L0 of the sheet metal strip prior to bending of the sheet metal workpiece,
bending the sheet metal workpiece and placing the bent sheet metal workpiece against the measuring element surfaces (22, 23) with its outer surface,
determining the intersection/the intersections of straight extension lines of adjacent limbs or of straight lines parallel to the straight extension lines, said straight lines running at the surfaces of the limbs facing away from the respective bending axis,
determining the distances A1, A2 between the intersection/the intersections and the free ends (12, 13) of the limbs and determining the n−1 distances Bⱼ between the intersections,
wherein the free ends (12, 13) of the limbs are measured using a contactless measuring method,
determining a tangent shortening T according to the formula:
T=L0−Σᵢ₌₁²Aᵢ . . . n=1
T=L0−Σᵢ₌₁²Aᵢ−B₁ . . . n=2
T=L0−Σᵢ₌₁²−Aᵢ−Σⱼ₌₁ⁿ⁻¹Bⱼ . . . n≥3

2: The method for estimating a shortening length of a sheet metal workpiece which is bent about n bending axes and by n bending angles, with a bending angle alpha<90°,
wherein a measuring arrangement with a first measuring element surface (22) of a first measuring element (20) and with a second measuring element surface (23) of a second measuring element (21) is used, and
wherein the measuring elements (20, 21) are formed by parts of the bending machine and the first and the second measuring element surfaces (22, 23) are arranged at an angle of 90° relative to one another, and
wherein the bent sheet metal workpiece comprises at least n+1 limbs extending along straight extension lines and n curved regions which are produced by bending the sheet metal workpiece and extend between adjacent limbs, comprising the following method steps:
determining the original length L0 of the sheet metal strip prior to bending of the sheet metal workpiece,
bending the sheet metal workpiece and placing the bent sheet metal workpiece against the measuring element surfaces (22, 23) with its outer surface,
determining edge lengths C₁ C₂ of the bent sheet metal workpiece, said edge lengths C₁ C₂ each indicating a distance from a free end (12, 13) of a limb to a tangent point to be measured in parallel to the straight extension line of the limb, at which tangent point a tangent normal to the first straight extension line is tangent to the curved region,
determining n−1 edge lengths D₁ of the bent sheet metal workpiece, said edge lengths D₁ indicating a distance from the tangent point to a further tangent point to be measured in parallel to the straight extension line of the limb, at which tangent points tangents normal to the straight extension lines are tangent to the curved region,
wherein the free ends (12, 13) of the limbs are measured using a contactless measuring method,
calculating the edge shortening length K according to the following formula:
K=L0−Σᵢ₌₁²Cᵢ . . . n=1
K=L0−Σᵢ₌₁²Cᵢ−D₁ . . . n=2
K=L0−Σₖ₌₁ⁿ⁺¹Cₖ−Σₗ₋₁ⁿ⁻¹Cₗ . . . n≥3

3-4. (canceled)
